(19) United States
(12) Patent Application Publication
(10) Pub. No.: US 2023/0092468 A1
(43) Pub. Date: Mar. 23, 2023

(54) STACKED OBJECT RECOGNITION METHOD, APPARATUS AND DEVICE, AND COMPUTER STORAGE MEDIUM

(71) Applicant: SENSETIME INTERNATIONAL PTE. LTD., Singapore (SG)

(72) Inventors: Jinghuan CHEN, Singapore (SG); Kaige Chen, Singapore (SG)

(21) Appl. No.: 17/489,125

(22) Filed: Sep. 29, 2021

Related U.S. Application Data
(63) Continuation of application No. PCT/IB2021/058782, filed on Sep. 27, 2021.

(30) Foreign Application Priority Data
Sep. 21, 2021 (SG) 10202110411X

(51) Int. Cl. G06K 9/00; G06K 9/46; G06K 9/62; G06T 7/13; G06T 7/174; G06N 20/00

(52) U.S. Cl. CPC G06K 9/00624; G06K 9/4604; G06K 9/6268; G06T 7/13; G06T 7/174; G06N 20/00

(57) ABSTRACT

Provided are a stacked object recognition method, apparatus and device, and a computer storage medium. The method includes that: an image to be recognized is acquired, the image to be recognized including an object sequence formed by stacking at least one object; edge detection and semantic segmentation are performed on the object sequence based on the image to be recognized to determine an edge segmentation image of the object sequence and a semantic segmentation image of the object sequence, the edge segmentation image including edge information of each object of the object sequence and each pixel in the semantic segmentation image representing a class of the object to which the pixel belongs; and the class of each object in the object sequence is determined based on the edge segmentation image and the semantic segmentation image.

### CROSS-REFERENCE TO RELATED APPLICATION(S)

The application is continuation of international application PCT/IB2021/058782 filed on 27 Sep. 2021, which claims priority to Singaporean patent application No. 10202110411X filed with IPOS on 21 Sep. 2021. The contents of international application PCT/IB2021/058782 and Singaporean patent application No. 10202110411X are incorporated herein by reference in their entireties.

### TECHNICAL FIELD

Embodiments of the disclosure relate, but are not limited, to the technical field of computer vision, and particularly to a stacked object recognition method, apparatus and device, and a computer storage medium.

### BACKGROUND

Image-based object recognition is an important research subject in computer vision. In some scenes, many products are required to be produced or used in batches, and these products may form object sequences by object stacking. In such case, a class of each object in the object sequence is required to be recognized. In a related method, Connectionist Temporal Classification (CTC) may be adopted for image recognition. However, a prediction effect of the method needs to be improved.

### SUMMARY

The embodiments of the disclosure provide a stacked object recognition method, apparatus and device, and a computer storage medium.

A first aspect provides a stacked object recognition method, which may include the following operations. An image to be recognized is acquired, the image to be recognized including an object sequence formed by stacking at least one object. Edge detection and semantic segmentation are performed on the object sequence based on the image to be recognized to determine an edge segmentation image of the object sequence and a semantic segmentation image of the object sequence, the edge segmentation image including edge information of each object of the object sequence and each pixel in the semantic segmentation image representing a class of the object to which the pixel belongs. The class of each object in the object sequence is determined based on the edge segmentation image and the semantic segmentation image.

In some embodiments, the operation that the class of each object in the object sequence is determined based on the edge segmentation image and the semantic segmentation image may include the following operations. A boundary position of each object in the object sequence in the image to be recognized is determined based on the edge segmentation image The class of each object in the object sequence is determined based on pixel values of pixels in a region corresponding to the boundary position of each object in the semantic segmentation image, the pixel value of the pixel representing a class identifier of the object to which the pixel belongs.

Accordingly, the boundary position of each object in the object sequence is determined based on the edge segmentation image, and the class of each object in the object sequence is determined based on the pixel values of the pixels in the region corresponding to the boundary position of each object in the semantic segmentation image. Therefore, pixel values of pixels in a region corresponding to each object in the object sequence may be determined accurately based on the boundary position of each object to further determine the class of each object in the object sequence accurately.

In some embodiments, the operation that the class of each object in the object sequence is determined based on pixel values of pixels in a region corresponding to the boundary position of each object in the semantic segmentation image may include that: for each object, the pixel values of the pixels in the region corresponding to the boundary position of the object in the semantic segmentation image are statistically obtained; the pixel value corresponding to a maximum number of pixels in the region is determined according to a statistical result; and a class identifier represented by the pixel value corresponding to the maximum number of pixels is determined as a class identifier of the object.

Accordingly, the pixel values of the pixels in the region corresponding to the boundary position of the object in the semantic segmentation image are statistically obtained, and the class identifier represented by the pixel value corresponding to the maximum number of pixels is determined as the class identifier of the object, so that the class of each object in the object sequence may be determined accurately.

In some embodiments, the operation that edge detection and semantic segmentation are performed on the object sequence based on the image to be recognized to determine an edge segmentation image of the object sequence and a semantic segmentation image of the object sequence may include the following operations. Convolution processing and pooling processing are sequentially performed one time on the image to be recognized to obtain a first pooled image. At least one first operation is performed based on the first pooled image, the first operation including sequentially performing convolution processing one time and pooling processing one time based on an image obtained from latest pooling processing to obtain a first intermediate image. Merging processing and down-sampling processing are performed on the first pooled image and each first intermediate image to obtain the edge segmentation image. At least one second operation is performed based on a first intermediate image obtained from a last first operation, the second operation including sequentially performing convolution processing one time and pooling processing one time based on an image obtained from latest pooling processing to obtain a second intermediate image. Merging processing and down-sampling processing are performed on the first intermediate image obtained from the last first operation and each second intermediate image to obtain the semantic segmentation image.

Accordingly, the merging processing and down-sampling processing are performed on the first pooled image and each first intermediate image to obtain the edge segmentation image, and the semantic segmentation image is obtained based on the first intermediate image obtained from the last first operation, so that the first intermediate image obtained from the last first operation may be shared to further reduce the consumption of calculation resources. In addition, the edge segmentation image is obtained by performing the merging processing and down-sampling processing on the first pooled image and each first intermediate image, and the semantic segmentation image is obtained by performing the merging processing and down-sampling processing on the first intermediate image obtained from the last first operation and each second intermediate image. Both the edge segmentation image and the semantic segmentation image are obtained by performing merging processing and down-sampling processing on multiple images, so that the obtained edge segmentation image and semantic segmentation image may be made highly accurate by use of features of the multiple images.

In some embodiments, the edge segmentation image may include a mask image representing the edge information of each object, and/or, the edge segmentation image may be the same as the image to be recognized in size. The semantic segmentation image may include a mask image representing semantic information of each pixel, and/or, the semantic segmentation image may be the same as the image to be recognized in size.

Accordingly, the edge segmentation image includes the mask image representing the edge information of each object, so that the edge information of each object may be determined easily based on the mask image The edge segmentation image is the same as the image to be recognized in size, so that an edge position of each object may be determined accurately based on an edge position of each object in the edge segmentation image. The semantic segmentation image includes the mask image representing the semantic information of each pixel, so that the semantic information of each pixel may be determined easily based on the mask image. The semantic segmentation image is the same as the image to be recognized in size, so that a statistical condition of the semantic information of pixels in a region corresponding to the edge position of each object may be determined accurately based on the semantic information of each pixel in the semantic segmentation image.

In some embodiments, the edge segmentation image may be a binarized mask image.

A pixel with a first pixel value in the edge segmentation image may correspond to an edge pixel of each object in the image to be recognized. A pixel with a second pixel value in the edge segmentation image may correspond to a non-edge pixel of each object in the image to be recognized.

Accordingly, the edge segmentation image is a binarized mask image, so that whether each pixel is an edge pixel of each object in the object sequence may be determined based on whether the pixel in the binarized mask image has the first pixel value or the second pixel value, and further, an edge of each object in the object sequence may be determined easily.

In some embodiments, the operation that edge detection and semantic segmentation are performed on the object sequence based on the image to be recognized to determine an edge segmentation image of the object sequence and a semantic segmentation image of the object sequence may include the following operations. The image to be recognized is input to a trained edge detection model to obtain an edge detection result of each object in the object sequence, the edge detection model being obtained by training based on a sequence object image including object edge labeling information. The edge segmentation image of the object sequence is generated according to the edge detection result. The image to be recognized is input to a trained semantic segmentation model to obtain a semantic segmentation result of each object in the object sequence, the semantic segmentation model being obtained by training based on a sequence object image including object semantic segmentation labeling information. The semantic segmentation image of the object sequence is generated according to the semantic segmentation result.

Accordingly, the image to be recognized may be input to the trained edge detection model and the trained semantic segmentation model to obtain the edge segmentation image and the semantic segmentation image based on the two models, and the image may be processed concurrently through the trained edge detection model and the trained semantic segmentation model, so that the edge segmentation image and the semantic segmentation image may be obtained rapidly.

In some embodiments, the operation that the class of each object in the object sequence is determined based on the edge segmentation image and the semantic segmentation image may include the following operations. The edge segmentation image and the semantic segmentation image are fused to obtain a fusion image including the semantic segmentation image and the edge information of each object displayed in the semantic segmentation image A pixel value corresponding to a maximum number of pixels in a region corresponding to the edge information of each object is determined in the fusion image. A class represented by the pixel value corresponding to the maximum number of pixels is determined as the class of each object.

Accordingly, the fusion image includes the semantic segmentation image and the edge information of each object displayed in the semantic segmentation image, so that the edge information of each object and the pixel values of the pixels in the region corresponding to the edge information of each object may be determined accurately to further determine the class of each object in the object sequence accurately.

In some embodiments, the object may have a value attribute corresponding to the class. The method may further include that: a total value of objects in the object sequence is determined based on the class of each object and the corresponding value attribute.

Accordingly, the total value of the objects in the object sequence is determined based on the class of each object and the corresponding value attribute, so that it may be convenient to statistically obtain the total value of the stacked object. For example, it is convenient to detect and determine a total value of stacked tokens.

A second aspect provides a stacked object recognition apparatus, which may include an acquisition unit, a determination unit, and a recognition unit. The acquisition unit may be configured to acquire an image to be recognized, the image to be recognized including an object sequence formed by stacking at least one object. The determination unit may be configured to perform edge detection and semantic segmentation on the object sequence based on the image to be recognized to determine an edge segmentation image of the object sequence and a semantic segmentation image of the object sequence, the edge segmentation image including edge information of each object of the object sequence and each pixel in the semantic segmentation image representing a class of the object to which the pixel belongs. The recognition unit may be configured to determine the class of each object in the object sequence based on the edge segmentation image and the semantic segmentation image.

In some embodiments, the recognition unit may further be configured to determine a boundary position of each object in the object sequence in the image to be recognized based on the edge segmentation image and determine the class of each object in the object sequence based on pixel values of pixels in a region corresponding to the boundary position of each object in the semantic segmentation image, the pixel value of the pixel representing a class identifier of the object to which the pixel belongs.

In some embodiments, the recognition unit may further be configured to, for each object, statistically obtain the pixel values of the pixels in the region corresponding to the boundary position of the object in the semantic segmentation image, determine the pixel value corresponding to a maximum number of pixels in the region according to a statistical result and determine a class identifier represented by the pixel value corresponding to the maximum number of pixels as a class identifier of the object.

In some embodiments, the determination unit may further be configured to: sequentially perform convolution processing one time and pooling processing one time on the image to be recognized to obtain a first pooled image, perform at least one first operation based on the first pooled image, the first operation including sequentially performing convolution processing one time and pooling processing one time based on an image obtained from latest pooling processing to obtain a first intermediate image; perform merging processing and down-sampling processing on the first pooled image and each first intermediate image to obtain the edge segmentation image; perform at least one second operation based on a first intermediate image obtained from a last first operation, the second operation including sequentially performing convolution processing one time and pooling processing one time based on an image obtained from latest pooling processing to obtain a second intermediate image; and perform merging processing and down-sampling processing on the first intermediate image obtained from the last first operation and each second intermediate image to obtain the semantic segmentation image.

In some embodiments, the edge segmentation image may include a mask image representing the edge information of each object, and/or, the edge segmentation image may be the same as the image to be recognized in size. The semantic segmentation image may include a mask image representing semantic information of each pixel, and/or, the semantic segmentation image may be the same as the image to be recognized in size.

In some embodiments, the edge segmentation image may be a binarized mask image. A pixel with a first pixel value in the edge segmentation image may correspond to an edge pixel of each object in the image to be recognized. A pixel with a second pixel value in the edge segmentation image may correspond to a non-edge pixel of each object in the image to be recognized.

In some embodiments, the determination unit may further be configured to input the image to be recognized to a trained edge detection model to obtain an edge detection result of each object in the object sequence, the edge detection model being obtained by training based on a sequence object image including object edge labeling information, generate the edge segmentation image of the object sequence according to the edge detection result, input the image to be recognized to a trained semantic segmentation model to obtain a semantic segmentation result of each object in the object sequence, the semantic segmentation model being obtained by training based on a sequence object image including object semantic segmentation labeling information, and generate the semantic segmentation image of the object sequence according to the semantic segmentation result.

In some embodiments, the recognition unit may further be configured to fuse the edge segmentation image and the semantic segmentation image to obtain a fusion image including the semantic segmentation image and the edge information of each object displayed in the semantic segmentation image, determine a pixel value corresponding to a maximum number of pixels in a region corresponding to the edge information of each object in the fusion image and determine a class represented by the pixel value corresponding to the maximum number of pixels as the class of each object.

In some embodiments, the object may have a value attribute corresponding to the class. The determination unit may further be configured to determine a total value of objects in the object sequence based on the class of each object and the corresponding value attribute.

A third aspect provides a stacked object recognition device, which may include a memory and a processor.

The memory may store a computer program capable of running in the processor.

The processor may execute the computer program to implement the steps in the abovementioned method.

A fourth aspect provides a computer storage medium storing one or more programs which may be executed by one or more processors to implement the steps in the abovementioned method.

In the embodiments of the disclosure, the class of each object in the object sequence is determined based on the edge segmentation image and the semantic segmentation image. As such, not only is the edge information of each object determined based on the edge segmentation image considered, but also the class, determined based on the semantic segmentation image, of the object each pixel belongs to is considered. Therefore, the determined class of each object in the object sequence in the image to be recognized is highly accurate.

### BRIEF DESCRIPTION OF THE DRAWINGS

It is apparent that the drawings described below are only some embodiments of the disclosure. Other drawings may further be obtained by those of ordinary skill in the art according to these drawings without creative work.

FIG. 1 is a structure diagram of a stacked object recognition system according to an embodiment of the disclosure.

FIG. 2 is an implementation flowchart of a stacked object recognition method according to an embodiment of the disclosure.

FIG. 3 is an implementation flowchart of another stacked object recognition method according to an embodiment of the disclosure.

FIG. 4 is an implementation flowchart of another stacked object recognition method according to an embodiment of the disclosure.

FIG. 5 is an implementation flowchart of another stacked object recognition method according to an embodiment of the disclosure.

FIG. 6 is a schematic flow block diagram of a stacked object recognition method according to an embodiment of the disclosure.

FIG. 7 is a schematic diagram of an architecture of a target segmentation model according to an embodiment of the disclosure.

FIG. 8 is a composition structure diagram of a stacked object recognition apparatus according to an embodiment of the disclosure.

FIG. 9 is a schematic diagram of a hardware entity of a stacked object recognition device according to an embodiment of the disclosure.

### DETAILED DESCRIPTION

The following specific embodiments may be combined. The same or similar concepts or processing will not be elaborated in some embodiments.

It is to be noted that, in the embodiments of the disclosure, “first”, “second” and the like are adopted to distinguish similar objects and not intended to describe a specific sequence or order.

In addition, the embodiments of the disclosure may be freely combined without conflicts.

At least one and at least one frame in the embodiments of the disclosure may refer to one or at least two and one frame or at least two frames respectively. Multiple and multiple frames in the embodiments of the disclosure may refer to at least two and at least two frames respectively. In the embodiments of the disclosure, at least one frame of image may be continuously shot images or discontinuously shot images. The number of images may be determined based on a practical condition, and no limits are made thereto in the embodiments of the disclosure.

In order to alleviate and even avoid human resource waste caused by the manual determination of a class of each object in an object sequence formed by stacking, it is proposed to recognize each object in the object sequence in a computer vision manner. For example, the following two schemes are proposed.

First scheme: After the object sequence is shot to obtain an image, a feature of the image may be extracted at first using a Convolutional Neural Network (CNN), then sequence modeling is performed on the feature using a Recurrent Neural Network (RNN), class prediction and duplication elimination are performed on each feature slice using an CTC loss function to obtain an output result, and a class of each object in the object sequence may be determined based on the output result. However, as for the method, the training of an RNN sequence modeling part is time-consuming, a model may be independently supervised using a CTC loss only, and a prediction effect is limited.

Second scheme: After the object sequence is shot to obtain an image, a feature of the image may be extracted at first using a CNN, then an attention center is generated in combination with a visual attention mechanism, a corresponding result is predicted for each attention center, and other redundant information is ignored. However, as for the method, the attention mechanism has relatively high requirements on calculations and memory usage.

Therefore, there is no related algorithm specially for the recognition of each object in an object sequence formed by stacking. Although the two methods may be used for the recognition of object sequences, an object sequence is usually long, stacked objects are in similar shapes, and the number of the stacked objects is indefinite, so that the class of each object in the object sequence cannot be predicted highly accurately using the two methods.

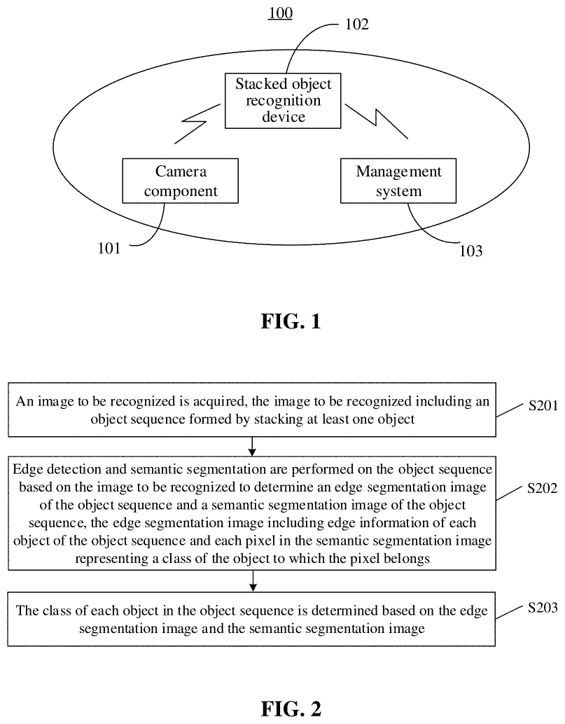

FIG. 1 is a structure diagram of a stacked object recognition system according to an embodiment of the disclosure. As shown in FIG. 1, the stacked object recognition system 100 may include a camera component 101, a stacked object recognition device 102, and a management system 103.

In some implementation modes, the camera component 101 may include multiple cameras which may shoot a surface for placing objects from different angles. The surface for placing objects may be a surface of a game table or a placement stage, etc. For example, the camera component 101 may include three cameras. A first camera may be a bird's eye view camera, and may be erected at a top of the surface for placing objects. A second camera and a third camera are erected on a side of the surface for placing objects respectively, and an included angle between the second camera and the third camera is a set included angle. For example, the set included angle may be 30 degrees to 120 degrees, and the set included angle may be 30 degrees, 60 degrees, 90 degrees, or 120 degrees. The second camera and the third camera may be arranged on the surface for placing objects to shoot conditions of the objects on the surface for placing objects as well as players from a side view.

In some implementation modes, the stacked object recognition device 102 may correspond to only one camera component 101. In some other implementation modes, the stacked object recognition device 102 may correspond to multiple camera components 101. Both the stacked object recognition device 102 and the surface for placing objects may be arranged in a specified space (e.g., a game place). For example, the stacked object recognition device 102 may be an end device, and may be connected with a server in the specified space. In some other implementation modes, the stacked object recognition device 102 may be arranged at a cloud.

The camera component 101 may be in communication connection with the stacked object recognition device 102. In some implementation modes, the camera component 101 may shoot real-time images periodically or aperiodically and send the shot real-time images to the stacked object recognition device 102. For example, under the condition that the camera component 101 includes multiple cameras, the multiple cameras may shoot real-time images at an interval of a target time length and send the shot real-time images to the stacked object recognition device 102. The multiple cameras may shoot real-time images at the same time or at different time. In some other implementation modes, the camera component 101 may shoot real-time videos and send the real-time videos to the stacked object recognition device 102. For example, under the condition that the camera component 101 includes multiple cameras, the multiple cameras may send shot real-time videos to the stacked object recognition device 102 respectively such that the stacked object recognition device 102 extracts real-time images from the real-time videos. The real-time image in the embodiments of the disclosure may be any one or more of the following images.

The stacked object recognition device 102 may analyze the objects on the surface for placing objects in the specified space and actions of targets (e.g., game participants, including a game controller and/or players) at the surface for placing objects based on the real-time images to determine whether the actions of the targets conform to the specification or proper.

The stacked object recognition device 102 may be in communication connection with the management system 103. The management system may include a display device. When the stacked object recognition device 102 determines that the action of a target is improper, the stacked object recognition device 102 may send alert information to the management system 103 corresponding to the target whose action is improper and arranged on the surface for placing objects such that the management system 103 may output an alert corresponding to the alert information.

In the embodiment corresponding to FIG. 1, the camera component 101, the stacked object recognition device 102 and the management system 103 are independent respectively. However, in another embodiment, the camera component 101 may be integrated with the stacked object recognition device 102, or, the stacked object recognition device 102 may be integrated with the management system 103, or, the camera component 101, the stacked object recognition device 102 and the management system 103 may be integrated.

The stacked object recognition method in the embodiment of the disclosure may be applied to game, entertainment and competition scenes, and the object may include a token, a game card, a game chip, etc., in the scene. No specific limits are made thereto in the disclosure.

FIG. 2 is an implementation flowchart of a stacked object recognition method according to an embodiment of the disclosure. As shown in FIG. 2, the method is applied to a stacked object recognition apparatus. The method includes the following operations.

In S201, an image to be recognized is acquired, the image to be recognized including an object sequence formed by stacking at least one object.

In some implementation modes, the stacked object recognition apparatus may include a stacked object recognition device. In some other implementation modes, the stacked object recognition apparatus may include a processor or chip which may be applied to a stacked object recognition device. The stacked object recognition device may include one or combination of at least two of a server, a mobile phone, a pad, a computer with a wireless transceiver function, a palm computer, a desktop computer, a personal digital assistant, a portable media player, an intelligent speaker, a navigation device, a wearable device such as a smart watch, smart glasses and a smart necklace, a pedometer, a digital Television (TV), a Virtual Reality (VR) terminal device, an Augmented Reality (AR) terminal device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, a vehicle, vehicle-mounted device and vehicle-mounted module in an Internet of vehicles system, etc.

A camera erected on a side of a surface for placing objects may shoot the object sequence to obtain a shot image. The camera may shoot the object sequence at a set time interval, and the shot image may be an image presently shot by the camera. In an embodiment, the camera may shoot a video, and the shot image may be an image extracted from the video. The image to be recognized may be determined based on the shot image. When one camera shoots the object sequence, an image shot by the camera may be determined as a shot image. When at least two cameras shoot the object sequence, images shot by the at least two cameras may be determined as at least two frames of shot images respectively. The image to be recognized may include a frame of image or at least two frames of images, and the at least two frames of images may be determined based on at least two frames of shot images respectively. In some other embodiments, the image to be recognized may be determined based on images acquired from another video source. For example, the acquired images may be directly stored in the video source, or, the acquired images may be extracted from a video stored in the video source.

In some implementation modes, the shot image or the acquired image may be directly determined as the image to be recognized.

In some other implementation modes, at least one of the following processing may be performed on the shot image or the acquired image to obtain the image to be recognized: scaling processing, cropping processing, de-noising processing, noise addition processing, gray-scale processing, rotation processing, and normalization processing.

In some other implementation modes, object detection may be performed on the shot image or the acquired image to obtain an object detection box (e.g., a rectangular box), and the shot image is cropped based on the object detection box to obtain the image to be recognized. For example, when a shot image includes an object sequence, an image to be recognized is determined based on the shot image. For another example, when a shot image includes at least two object sequences, an image to be recognized including the at least two object sequences may be determined based on the shot image, or, at least two images to be recognized in one-to-one correspondence with the at least two object sequences may be determined based on the shot image. In another implementation mode, the image to be recognized may be obtained by cropping after performing at least one of the following processing on the shot image or performing at least one of the following processing after cropping the shot image: scaling processing, cropping processing, de-noising processing, noise addition processing, gray-scale processing, rotation processing, and normalization processing.

In some other implementation modes, the image to be recognized is extracted from the shot image or the acquired image, and at least one edge of the object sequence in the image to be recognized may be aligned with at least one edge of the image to be recognized respectively. For example, one or each edge of the object sequence in the image to be recognized is aligned with one or each edge of the image to be recognized.

In the embodiment of the disclosure, there may be one or at least two object sequences. The at least one object may be stacked to form one object sequence or at least two object sequences. Each object sequence may refer to a pile of objects formed by stacking in a stacking direction. An object sequence may include regularly stacked objects or irregularly stacked objects.

In the embodiment of the disclosure, the object may include at least one of a flaky object, a blocky object, a bagged object, etc. The object in the object sequence may include objects in the same form or objects in different forms. Any two adjacent objects in the object sequence may be in direct contact. For example, one object is placed on the other object. In an embodiment, any two adjacent objects in the object sequence may be adhered through another object, including any adhesive object such as glue or an adhesive.

When the object includes a flaky object, the flaky object is an object with a thickness, and a thickness direction of the object may be a stacking direction of the object.

The at least one object in the object sequence has a set identifier on a surface along the stacking direction (or called a lateral surface). In the embodiment of the disclosure, different appearance identifiers representing classes may be set on lateral surfaces of different objects in the object sequence in the image to be recognized to distinguish different objects. The appearance identifier may include at least one of a size, a color, a pattern, a texture, a text on the surface, etc. The lateral surface of the object may be parallel to the stacking direction (or the thickness direction of the object).

The object in the object sequence may be a cylindrical, prismatic, circular truncated cone-shaped or truncated pyramid-shaped object, or another regular or irregular flaky object. In some implementation scenes, the object in the object sequence may be a token. The object sequence may be formed by longitudinally or horizontally stacking multiple tokens. Different types of tokens have different currency values or face values, and tokens with different currency values may be different in at least one of size, color, pattern and token sign. Therefore, in the embodiment of the disclosure, a class of a currency value corresponding to each token in an image to be recognized may be detected according to the obtained image to be recognized including at least one token to obtain a currency value classification result of the token. In some embodiments, the token may include a game chip, and the currency value of the token may include a chip value of the chip.

In S202, edge detection and semantic segmentation are performed on the object sequence based on the image to be recognized to determine an edge segmentation image of the object sequence and a semantic segmentation image of the object sequence, the edge segmentation image including edge information of each object of the object sequence and each pixel in the semantic segmentation image representing a class of the object to which the pixel belongs.

In some embodiments, the operation that edge detection and semantic segmentation are performed on the object sequence based on the image to be recognized to determine an edge segmentation image of the object sequence and a semantic segmentation image of the object sequence may include the following operations. Edge detection is performed on the object sequence based on the image to be recognized to determine the edge segmentation image of the object sequence. Semantic segmentation is performed on the object sequence based on the image to be recognized to determine the semantic segmentation image of the object sequence.

For example, the operation that edge detection is performed on the object sequence based on the image to be recognized to determine the edge segmentation image of the object sequence may include that: the image to be recognized is input to an edge segmentation model (or called an edge segmentation network), edge detection is performed on the object sequence in the image to be recognized through the edge segmentation model, and the edge segmentation image of the object sequence is output through the edge segmentation model. The edge segmentation network may be a segmentation model for an edge of each object in the object sequence.

For example, the operation that semantic segmentation is performed on the object sequence based on the image to be recognized to determine the semantic segmentation image of the object sequence may include that: the image to be recognized is input to a semantic segmentation model (or called a semantic segmentation network), semantic segmentation is performed on the object sequence in the image to be recognized through the semantic segmentation model, and the semantic segmentation image of the object sequence is output through the semantic segmentation model. The semantic segmentation network may be a neural network for a class of each pixel in the object sequence.

In the embodiment of the disclosure, the edge segmentation model may be a trained edge segmentation model. For example, the trained edge segmentation model may be determined by training an initial edge segmentation model through a first training sample. The first training sample may include multiple labeled images, of which each includes an object sequence and labeling information of a contour of each object.

In the embodiment of the disclosure, the semantic segmentation model may be a trained semantic segmentation model. For example, the trained semantic segmentation model may be determined by training an initial semantic segmentation model through a second training sample. The second training sample may include multiple labeled images, of which each includes an object sequence and labeling information of a class of each object.

The edge segmentation network may include one of a Richer Convolutional Features for Edge Detection (RCF) network, a Holistically-nested Edge Detection (HED) network, a Canny edge detection network, evolved networks of these networks, etc.

The semantic segmentation network may include one of a Fully Convolution Network (FCN), a SegNet, a U-Net, DeepLab v1, DeepLab v2, DeepLab v3, a fully convolutional DenseNet, an E-Net, a Link-Net, a Mask R-CNN, a Pyramid Scene Parsing Network (PSPNet), a RefineNet, a Gated Feedback Refinement Network (G-FRNet), evolved networks of these networks, etc.

In some other implementation modes, a trained target segmentation model (or called a target segmentation network) may be acquired, the image to be recognized is input to the trained target segmentation model, and the edge segmentation image of the object sequence and the semantic segmentation image of the object sequence are output through the trained target segmentation model. The trained target segmentation model may be obtained by integrating an edge detection network into a structure of a deep-learning-based semantic segmentation neural network. The deep-learning-based semantic segmentation neural network may include an FCN, and the edge detection network may include an RCF network.

Pixel sizes of the edge segmentation image and the semantic segmentation image may both be the same as that of the image to be recognized. For example, the pixel size of the image to be recognized is 800×600 or 800×600×3, where 800 is a pixel size of the image to be recognized in a width direction, 600 is a pixel size of the image to be recognized in a height direction, and 3 is the channel number of the image to be recognized, channels including three channels, i.e., Red Green Blue (RGB) channels. In such case, the pixel sizes of the edge segmentation image and the semantic segmentation image are both 800×600.

Edge segmentation is performed on the image to be recognized for a purpose of implementing binary classification on each pixel in the image to be recognized to determine whether each pixel in the image to be recognized is an edge pixel of an object. When a certain pixel in the image to be recognized is an edge pixel of an object, an identifier value of a corresponding pixel in the edge segmentation image may be determined as a first value. When a certain pixel in the image to be recognized is not an edge pixel of an object, an identifier value of a corresponding pixel in the edge segmentation image may be determined as a second value. The first value is different from the second value. The first value may be 1, and the second value may be 0. In an embodiment, the first value may be 0, and the second value may be 1. In this manner, an identifier value of each pixel in the edge segmentation image is the first value or the second value, so that an edge of each object in the object sequence in the image to be recognized may be determined based on positions of the first values and second values in the edge segmentation image. In some implementation modes, the edge segmentation image may be called an edge mask.

Semantic segmentation is performed on the image to be recognized for a purpose of implementing semantic classification on each pixel in the image to be recognized to determine that each pixel in the image to be recognized belongs to a certain object or a background. When a certain pixel in the image to be recognized belongs to the background, an identifier value of a corresponding pixel in the semantic segmentation image may be determined as a third value. When a certain pixel in the image to be recognized belongs to an object of a target class in N classes, an identifier value of a corresponding pixel in the semantic segmentation image may be determined as a value corresponding to the object of the target class. N is an integer more than or equal to 1. The object of the target class also corresponds to N values. The third value may be 0. In this manner, an identifier value of each pixel in the semantic segmentation image may include N+1 numerical values, N being the total number of the classes of the objects, so that positions of a background portion and objects of each class in the image to be recognized may be determined based on positions of different values in the semantic segmentation image. In some implementation modes, the semantic segmentation image may be called a Segm mask.

In S203, the class of each object in the object sequence is determined based on the edge segmentation image and the semantic segmentation image.

The semantic segmentation image obtained by semantic segmentation may have edge blur, inaccurate segmentation, etc. Therefore, if the class of each object in the object sequence is determined through the semantic segmentation image, the determined class of each object in the object sequence may not be so accurate. If the edge segmentation image is combined with the semantic segmentation image, not only is edge information of each object determined based on the edge segmentation image considered, but also the class of each object determined based on the semantic segmentation image is considered, so that the class of each object in the object sequence may be determined accurately.

When the object is a token, different classes of objects may refer to that tokens have different values (or face values).

In some implementation modes, the stacked object recognition apparatus may output the class of each object in the object sequence or output an identifier value corresponding to the class of each object in the object sequence when obtaining the class of each object in the object sequence. In some implementation modes, the identifier value corresponding to the class of each object may be a value of the object. When the object is a token, the class of each object may be represented by a value of the token.

For example, the class of each object or the identifier value corresponding to the class of each object may be output to a management system for the management system to display. For another example, the class of each object or the identifier value corresponding to the class of each object may be output to an action analysis apparatus in the stacked object recognition device such that the action analysis apparatus may determine whether an action of a target around the surface for placing objects conforms to the specification based on the class of each object or the identifier value corresponding to the class of each object.

In some implementation modes, the action analysis apparatus may determine the increase or decrease of the number and/or total value of tokens in each placement region. The placement region may be a region for placing tokens on the surface for placing objects. For example, when the decrease of token and the appearance of a hand of a player in a certain placement region are determined in a payout stage of a game, it is determined that the player moves the tokens, and an alert is output to the management system to cause the management system to give an alert.

In the embodiment of the disclosure, the class of each object in the object sequence is determined based on the edge segmentation image and the semantic segmentation image. As such, not only is the edge information of each object determined based on the edge segmentation image considered, but also the class, determined based on the semantic segmentation image, of the object each pixel belongs to is considered. Therefore, the determined class of each object in the object sequence in the image to be recognized is highly accurate.

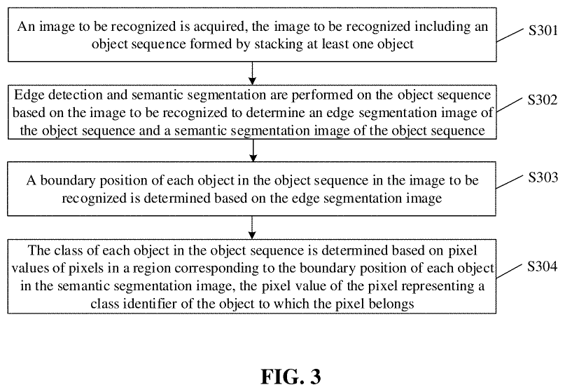

FIG. 3 is an implementation flowchart of another stacked object recognition method according to an embodiment of the disclosure. As shown in FIG. 3, the method is applied to a stacked object recognition apparatus. The method includes the following operations.

In S301, an image to be recognized is acquired, the image to be recognized including an object sequence formed by stacking at least one object.

In S302, edge detection and semantic segmentation are performed on the object sequence based on the image to be recognized to determine an edge segmentation image of the object sequence and a semantic segmentation image of the object sequence.

In S303, a boundary position of each object in the object sequence in the image to be recognized is determined based on the edge segmentation image.

The boundary position of each object may be determined based on a contour of the edge segmentation image. In some implementation modes, number information of the object in the object sequence may further be determined based on the edge segmentation image or the contour of the edge segmentation image. In some implementation modes, a boundary position of each object in the object sequence in the edge segmentation image or the image to be recognized may further be determined based on the number information of the object in the object sequence.

The number information of the object in the object sequence may be output after obtained. For example, the number information of the object in the object sequence may be output to the management system or the analysis apparatus for the management system to display or for the analysis apparatus to determine whether an action of a target conforms to the specification based on the number information of the object in the object sequence.

In some implementation modes, no matter whether sizes of objects of different classes are the same or different, a contour or boundary position of each object in the object sequence may be determined based on the edge segmentation image, and the number information of the object in the object sequence may be determined based on the contour or boundary position of each object.

In some other implementation modes, a total height of the object sequence and a width of any object may be determined based on the edge segmentation image when sizes of objects of different classes are the same. Since a ratio of a height to width of an object is fixed, the number information of the object in the object sequence may be determined based on the total height of the object sequence and the width of any object.

When the image to be recognized is a frame of image, a frame of edge segmentation image may be obtained based on the frame of image to be recognized, and the number information of the object in the object sequence may be determined based on the frame of edge segmentation image.

When the image to be recognized is at least two frames of images, the at least two frames of images to be recognized may be obtained based on at least two frames of shot images which may be obtained by shooting the object sequence at the same time from different angles, at least two frames of edge segmentation images may correspondingly be obtained based on the at least two frames of images to be recognized, and the number information of the object in the object sequence may be determined based on the at least two frames of edge segmentation images. In some implementation modes, number information of the object corresponding to the at least two frames of edge segmentation images respectively may be determined, and when the number information of the object corresponding to the at least two frames of edge segmentation images respectively is the same, the number information of the object corresponding to any edge segmentation image may be determined as the number of the object in the object sequence. When at least two pieces of number information in the number information of the object corresponding to the at least two frames of edge segmentation images are different, the most number information may be determined as the number information of the object in the object sequence, and the boundary position of each object in the object sequence is determined using the edge segmentation image corresponding to the most number information.

The boundary position of each object may be represented by first position information, which may be one-dimensional coordinate information or two-dimensional coordinate information. In some implementation modes, first position information of each object in the edge segmentation image or the image to be recognized may include starting position information and ending position information of an edge of each object in a stacking direction in the edge segmentation image or the image to be recognized. In some other implementation modes, first position information of each object in the edge segmentation image or the image to be recognized may include starting position information and ending position information of an edge of each object in a stacking direction as well as starting position information and ending position information of the edge of each object in a direction perpendicular to the stacking direction in the edge segmentation image or the image to be recognized.

For example, a width direction of the edge segmentation image may be an x axis, a height direction of the edge segmentation image may be a y axis, the stacking direction may be a y-axis direction, and the starting position information and ending position information of the edge of each object in the stacking direction may be coordinate information on the y axis or coordinate information on the x axis and the y axis. In some other implementation modes, first position information of each object in the edge segmentation image or the image to be recognized may include position information of an edge of each object or a key point on the edge of each object in the edge segmentation image or the image to be recognized.

When one frame of edge segmentation image is obtained, first position information of each object in the object sequence in the edge segmentation image may be determined based on the frame of edge segmentation image.

When at least two frames of edge segmentation images are obtained, a target edge segmentation image corresponding to most number information in number information of the object corresponding to the at least two frames of edge segmentation images respectively may be determined, and first position information of each object in the object sequence in the target edge segmentation image may be determined based on the target edge segmentation image corresponding to the most number information.

For example, two cameras shoot the object sequence from different angles respectively to obtain shot image A and shot image B, image to be recognized A and image to be recognized B are obtained based on shot image A and shot image B respectively, edge segmentation image A and edge segmentation image B are determined based on image to be recognized A and image to be recognized B respectively, and numbers C and D of objects are determined based on edge segmentation image A and edge segmentation image B respectively, C being greater than D, so that it is determined that the number of the object sequence is C, and first position information of each object in the object sequence in the edge segmentation image is determined based on edge segmentation image A.

In this manner, the first position information of each object in the object sequence in the edge segmentation image may still be determined accurately through an image shot from another angle when the object sequence is occluded at a certain angle or an edge contour shot at a certain angle is not so clear.

In S304, the class of each object in the object sequence is determined based on pixel values of pixels in a region corresponding to the boundary position of each object in the semantic segmentation image, the pixel value of the pixel representing a class identifier of the object to which the pixel belongs.

When the image to be recognized is at least two frames of images, two frames of edge segmentation images are obtained, two frames of semantic segmentation images are obtained, a target semantic segmentation image corresponding to a target edge segmentation image may be determined, and the class of each object in the object sequence may be recognized based on first position information and the target semantic segmentation image

In the embodiment of the disclosure, the boundary position of each object in the object sequence is determined based on the edge segmentation image, and the class of each object in the object sequence is determined based on the pixel values of the pixels in the region corresponding to the boundary position of each object in the semantic segmentation image. Therefore, pixel values of pixels in a region corresponding to each object in the object sequence may be determined accurately based on the boundary position of each object to further determine the class of each object in the object sequence accurately.

In some other implementation modes, S304 may be implemented in the following manner.

For each object, the following operations are performed.

The pixel values of the pixels in the region corresponding to the boundary position of the object in the semantic segmentation image are statistically obtained.

The pixel value corresponding to a maximum number of pixels in the region is determined according to a statistical result.

A class identifier represented by the pixel value corresponding to the maximum number of pixels is determined as a class identifier of the object.

A position of each object in the edge segmentation image may be the same as that of each object in the semantic segmentation image, so that the region corresponding to the boundary position of each object in the semantic segmentation image may be determined accurately. For example, in both the edge segmentation image and the semantic segmentation image, the origin is in the bottom left corner, the width direction is the x axis, and the height direction is the y axis. When boundary positions of four stacked objects in the edge segmentation image are (y0 y1), (y1, 2), (y2, y3), and (y3, y4), boundary positions in the semantic segmentation image are also (y0, y1), (y1, y2), (y2, y3), and (y3, y4). For another example, when boundary positions of four stacked objects in the edge segmentation image are ((x0, y0), (x1, y1)), ((x1, y1), (x2, y2)), ((x2, y2), (x3, y3)), and ((x3, y3), (x4, y4)), boundary positions in the semantic segmentation image are also ((x0, y0), (x1, y1)), ((x1, y1), (x2, y2)), ((x2, y2), (x3, y3)), and ((x3, y3), (x4, y4)).

For example, the number of pixels in a region corresponding to a boundary position of an object in the semantic segmentation image is M, and each pixel in the M pixels has a pixel value. In another embodiment, the pixel value of the pixel in the semantic segmentation image may be called an identifier value, an element value, or the like.

Different class identifiers represent different classes of objects. A corresponding relationship between a class identifier and a class of an object may be preset.

In the embodiment of the disclosure, the pixel values of the pixels in the region corresponding to the boundary position of the object (i.e., a region enclosed by a boundary of the object) in the semantic segmentation image are statistically obtained, and the class identifier represented by the pixel value corresponding to the maximum number of pixels is determined as the class identifier of the object, so that the class of each object in the object sequence may be determined accurately.

In some implementation modes, the operation that a class of each object in the object sequence is determined based on pixel values of pixels in a region corresponding to the boundary position of each object in the semantic segmentation image may include at least one of the following operations.

When pixel values of all pixels in a region corresponding to a boundary position of any object in the semantic segmentation image are a predetermined value, an object class corresponding to the predetermined value is determined as a class of the any object.

When pixel values of all pixels in a region corresponding to a boundary position of any object in the semantic segmentation image include two pixel values, number information of each same pixel value is determined, a number difference between the largest number information and the second largest number information is determined, and when the number difference is greater than a threshold, a class represented by the pixel value corresponding to the largest number information is determined as a class of the any object.

When the number difference is less than the threshold, a class/classes of one or two objects adjacent to the object is/are determined. When the class represented by the pixel value corresponding to the largest number information is the same as the class/classes of the adjacent one or two objects, a class represented by the pixel value corresponding to the second largest number information is determined as the class of the any object. When the class represented by the pixel value corresponding to the largest number information is different from the class/classes of the adjacent one or two objects, the class represented by the pixel value corresponding to the largest number information is determined as the class of the any object.

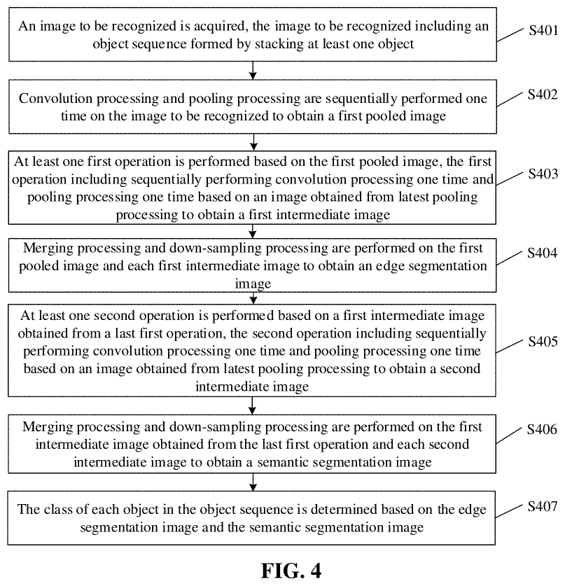

FIG. 4 is an implementation flowchart of another stacked object recognition method according to an embodiment of the disclosure. As shown in FIG. 4, the method is applied to a stacked object recognition apparatus. The method includes the following operations.

In S401, an image to be recognized is acquired, the image to be recognized including an object sequence formed by stacking at least one object.

In S402, convolution processing and pooling processing are sequentially performed one time on the image to be recognized to obtain a first pooled image

It is to be noted that any convolution processing described in the embodiment of the disclosure may be performing a round of convolution processing using a convolution kernel, or performing at least two rounds of convolution processing using a convolution kernel (for example, performing convolution processing one time using a convolution kernel after performing convolution processing one time using the convolution kerne1), or at least two rounds of convolution processing using at least two convolution kernels which may form a one-to-one correspondence or a one-to-many or many-to-one relationship with the at least two rounds.

When the convolution processing is performed one time on the image to be recognized, an obtained first convolved image includes one frame of image. When the convolution processing is performed at least two times on the image to be recognized, an obtained first convolved image includes at least two frames of images.

In some implementation modes, convolution processing may sequentially be performed twice on the image to be recognized to obtain a first convolved sub-image and a second convolved sub-image. The second convolved sub-image is obtained by convolving the first convolved sub-image. For example, convolution processing one time may be performed on an image to be processed using a 3×3×64 convolution kernel to obtain a first convolved sub-image, and then convolution processing one time is performed on the first convolved sub-image using the 3×3×64 convolution kernel to obtain a second convolved sub-image. Schematically, a first pooling processing may be performed on the second convolved sub-image to obtain a first pooled image.

In S403, at least one first operation is performed based on the first pooled image, the first operation including sequentially performing convolution processing one time and pooling processing one time based on an image obtained from latest pooling processing to obtain a first intermediate image.

For example, convolution processing one time and pooling processing one time may be performed on the first pooled image to obtain first intermediate image 1 after the first pooled image is obtained. Exemplarily, convolution processing one time and pooling processing one time may continue to be performed on obtained first intermediate image 1 to obtain first intermediate image 2. Exemplarily, convolution processing one time and pooling processing one time may continue to be performed on first intermediate image 2 to obtain first intermediate image 3. In this manner, at least one first intermediate image may sequentially be obtained.

In some embodiments, a first intermediate image is obtained every time when a first operation is performed. An execution count of the first operation may be preset.

In S404, merging processing and down-sampling processing are performed on the first pooled image and each first intermediate image to obtain an edge segmentation image.

A sequence of merging and down-sampling processing steps is not limited in the embodiment of the disclosure. For example, the down-sampling processing may be performed after the merging processing, or, the merging processing may be performed after the down-sampling processing.

The merging processing is performed after the down-sampling processing in S404. A down-sampled image the same as the image to be recognized in pixel size may be obtained through the down-sampling processing. At least two down-sampled images may be merged through the merging process. Therefore, an image obtained by merging may be endowed with a feature of each down-sampled image.

In some implementation processes, feature extraction may be performed on the first pooled image and each first intermediate image respectively to obtain at least two two-dimensional images. Then, the obtained at least two two-dimensional images are up-sampled respectively to obtain two up-sampled images the same as the image to be recognized in pixel size. Then, the edge segmentation image is determined based on a fusion image obtained by fusing the obtained two up-sampled images.

For example, convolution processing may be performed on the first pooled image and each first intermediate image respectively to obtain at least two two-dimensional images. Then, the at least two two-dimensional images are up-sampled respectively to obtain two up-sampled images the same as the image to be recognized in pixel size. Then, the two up-sampled images are fused to obtain a specific image the same as the image to be recognized in pixel size. Afterwards, whether each pixel in the specific image is an edge pixel is determined, thereby obtaining the edge segmentation image.

In some embodiments, S402 to S404 may be replaced with the following operations. Convolution processing one time is performed on the image to be recognized to obtain a first convolved image. At least one third operation is performed on the first convolved image, the third operation including sequentially performing pooling processing one time and convolution processing one time on an image obtained by a latest convolution processing to obtain a third intermediate image

Merging processing and down-sampling processing are performed on the first convolved image and each third intermediate image to obtain an edge segmentation image. Exemplarily, pooling processing one time may be performed on a latest third intermediate image to obtain a first intermediate image obtained by a latest first operation.

An implementation mode of obtaining the edge segmentation image will now be described.

Convolution processing is sequentially performed twice on the image to be recognized to obtain a first convolved sub-image and a second convolved sub-image, the second convolved sub-image is pooled to obtain a first pooled image, and the convolution processing is sequentially performed twice on the first pooled image to obtain a third convolved sub-image and a fourth convolved sub-image. Exemplarily, pooling processing one time may be performed on the fourth convolved sub-image to obtain a first intermediate image obtained by a latest first operation.

In some implementation modes, dimension reduction is performed on the first convolved sub-image and the second convolved sub-image respectively to obtain two dimension-reduced images. Dimension reduction is, for example, performing convolution processing on the first convolved sub-image and the second convolved sub-image using two 1×1×21 convolution kernels respectively. Then, the two dimension-reduced images are merged. An image obtained by merging is convolved using a 1×1×1 convolution kernel to obtain a two-dimensional image. Then, the two-dimensional image is up-sampled to obtain an up-sampled image the same as the image to be recognized in pixel size.

Dimension reduction may be performed on the third convolved sub-image and the fourth convolved sub-image respectively to obtain two dimension-reduced images Dimension reduction is, for example, performing convolution processing on the third convolved sub-image and the fourth convolved sub-image using two 1×1×21 convolution kernels respectively. Then, the two dimension-reduced images are merged. An image obtained by merging is convolved using a 1×1×1 convolution kernel to obtain another two-dimensional image. Then, the two-dimensional image is up-sampled to obtain another up-sampled image the same as the image to be recognized in pixel size.

Then, the obtained up-sampled image corresponding to the first convolved sub-image and the second convolved sub-image and the up-sampled image corresponding to the third convolved sub-image and the fourth convolved sub-image are merged to obtain a specific image the same as the image to be recognized in pixel size. Whether each pixel in the specific image is an edge pixel is determined, thereby obtaining the edge segmentation image.

In some implementation modes, merging processing and down-sampling processing may be performed on the first pooled image and each first intermediate image or on the first convolved image and each third intermediate image in manners similar to the above. For example, dimension reduction may be performed on the first pooled image and each first intermediate image respectively or on the first convolved image and each third intermediate image to obtain at least two dimension-reduced images respectively. Then, convolution processing one time is performed on each dimension-reduced image using a 1×1×1 convolution kernel to obtain at least two two-dimensional images respectively. Then, up-sampling processing is performed on the at least two two-dimensional images respectively to obtain at least two up-sampled images the same as the image to be recognized in pixel size. Merging processing is performed on the at least two up-sampled images to obtain a specific image. Whether each pixel in the specific image is an edge pixel is determined, thereby obtaining the edge segmentation image.

In S405, at least one second operation is performed based on a first intermediate image obtained from a last first operation, the second operation including sequentially performing convolution processing one time and pooling processing one time based on an image obtained from latest pooling processing to obtain a second intermediate image

In some implementation modes, S405 may be implemented in the following manner. Convolution processing and pooling processing are performed multiple times on the first intermediate image obtained from the last first operation to obtain a second pooled image, a third pooled image and a fourth pooled image respectively. A semantic segmentation image is obtained based on the second pooled image, the third pooled image and the fourth pooled image.

The operation that convolution processing and pooling processing are performed multiple times on the first intermediate image obtained from the last first operation to obtain a second pooled image, a third pooled image and a fourth pooled image respectively may include the following operations. Convolution processing one time and pooling processing one time are performed on the first intermediate image obtained from the last first operation to obtain the second pooled image. Convolution processing one time and pooling processing one time are performed on the second pooled image to obtain the third pooled image. Convolution processing one time and pooling processing one time are performed on the third pooled image to obtain the fourth pooled image.

In S406, merging processing and down-sampling processing are performed on the first intermediate image obtained from the last first operation and each second intermediate image to obtain a semantic segmentation image.

In S407, the class of each object in the object sequence is determined based on the edge segmentation image and the semantic segmentation image.

A pixel size of the first intermediate size obtained from the last first operation is larger than that of each second intermediate image. A pixel size of an image obtained by performing merging processing on the first intermediate image obtained from the last first operation and each second intermediate image may be the same as that of the first intermediate image obtained from the last first operation.

Down-sampling processing may be performed on the image obtained by the merging processing in S406 to obtain a target image the same as the image to be recognized in pixel size. Whether each pixel in the target image is an edge pixel may be determined to obtain the edge segmentation image.

An implementation mode of obtaining the semantic segmentation image based on the second pooled image, the third pooled image and the fourth pooled image will now be described.

The third pooled image is fused with the fourth pooled image to obtain a first fusion image. The second pooled image is fused with the first fusion image to obtain a second fusion image. The second fusion image is up-sampled to obtain an up-sampled image the same as the image to be analyzed in size. Then, the semantic segmentation image is obtained based on a classification result of each pixel in the determined up-sampled image.

In the embodiment of the disclosure, the merging processing and down-sampling processing are performed on the first pooled image and each first intermediate image to obtain the edge segmentation image, and the semantic segmentation image is obtained based on the first intermediate image obtained from the last first operation, so that the first intermediate image obtained from the last first operation may be shared to further reduce the consumption of calculation resources. In addition, the edge segmentation image is obtained by performing the merging processing and down-sampling processing on the first pooled image and each first intermediate image, and the semantic segmentation image is obtained by performing the merging processing and down-sampling processing on the first intermediate image obtained from the last first operation and each second intermediate image. Both the edge segmentation image and the semantic segmentation image are obtained by performing merging processing and down-sampling processing on multiple images, so that the obtained edge segmentation image and semantic segmentation image may be made highly accurate by use of features of the multiple images

It is to be noted that the merging processing and down-sampling processing are performed on the first pooled image and each first intermediate image to obtain the edge segmentation image. However, the embodiment of the disclosure is not limited thereto. In another embodiment, convolution processing may be performed one time on the image to be recognized to obtain a first convolved image. Pooling processing and convolution processing are sequentially performed one time on the first convolved image to obtain a second convolved image. Pooling processing and convolution processing are sequentially performed one time on the second convolved image to obtain a third convolved image. Pooling processing one time and convolution processing one time are sequentially performed on the third convolved image to obtain a fourth convolved image. Pooling processing and convolution processing are sequentially performed one time on the fourth convolved image to obtain a fifth convolved image. The edge segmentation image may be determined based on at least one of the first convolved image to the fifth convolved image. For example, the edge segmentation image may be determined only based on the first convolved image or the second convolved image For another example, the edge segmentation image may be determined based on all the first convolved image to the fifth convolved image. No limits are made thereto in the embodiment of the disclosure.

In some other embodiments, the edge segmentation image may be determined based on at least one of the first pooled image and each first intermediate image, or based on at least one of the first convolved image and each third intermediate image, or based on at least one of the first pooled image, each first intermediate image and each second intermediate image.

It is also to be noted that the semantic segmentation image is obtained based on the second pooled image, the third pooled image and the fourth pooled image. However, the embodiment of the disclosure is not limited thereto. In another embodiment, the semantic segmentation image may be obtained based on the third pooled image and the fourth pooled image. In an embodiment, the semantic segmentation image may be obtained only based on the fourth pooled image.

In some embodiments, the edge segmentation image includes a mask image representing the edge information of each object, and/or, the edge segmentation image is the same as the image to be recognized in size.

In some embodiments, the semantic segmentation image includes a mask image representing semantic information of each pixel, and/or, the semantic segmentation image is the same as the image to be recognized in size.

In the embodiment of the disclosure, that the edge segmentation image and/or the semantic segmentation image are/is the same as the image to be recognized in size may refer to that the edge segmentation image and/or the semantic segmentation image are the same as the image to be recognized in pixel size. That is, the numbers of pixels in a width direction and a height direction in the edge segmentation image and/or the semantic segmentation image are the same as that in the image to be recognized.

Accordingly, the edge segmentation image includes the mask image representing the edge information of each object, so that the edge information of each object may be determined easily based on the mask image The edge segmentation image is the same as the image to be recognized in size, so that an edge position of each object may be determined accurately based on an edge position of each object in the edge segmentation image. The semantic segmentation image includes the mask image representing the semantic information of each pixel, so that the semantic information of each pixel may be determined easily based on the mask image The semantic segmentation image is the same as the image to be recognized in size, so that a statistical condition of the semantic information of pixels in a region corresponding to the edge position of each object may be determined accurately based on the semantic information of each pixel in the semantic segmentation image.

In some embodiments, the edge segmentation image is a binarized mask image. A pixel with a first pixel value in the edge segmentation image corresponds to an edge pixel of each object in the image to be recognized. A pixel with a second pixel value in the edge segmentation image corresponds to a non-edge pixel of each object in the image to be recognized.

The pixel size of the edge segmentation image may be NxM, namely the edge segmentation image may include N×M pixels, a pixel value of each pixel in the N×M pixels being a first pixel value or a second pixel value. For example, when the first pixel value is 0 and the second pixel value is 1, pixels with the pixel value 0 are edge pixels of each object, and pixels with the pixel value 1 are non-edge pixels of each object. The non-edge pixel of each object may include a pixel, not at an edge, of each object in the object sequence, and may further include a background pixel of the object sequence.

Accordingly, the edge segmentation image is a binarized mask image, so that whether each pixel is an edge pixel of each object in the object sequence may be determined based on whether the pixel in the binarized mask image has the first pixel value or the second pixel value, and further, an edge of each object in the object sequence may be determined easily.

In some embodiments, S202 may include the following operations. The image to be recognized is input to a trained edge detection model to obtain an edge detection result of each object in the object sequence, the edge detection model being obtained by training based on a sequence object image including object edge labeling information. The edge segmentation image of the object sequence is generated according to the edge detection result. The image to be recognized is input to a trained semantic segmentation model to obtain a semantic segmentation result of each object in the object sequence, the semantic segmentation model being obtained by training based on a sequence object image including object semantic segmentation labeling information. The semantic segmentation image of the object sequence is generated according to the semantic segmentation result.

In some other embodiments, S202 may include the following operations. The image to be recognized is input to a trained target segmentation model to obtain an edge detection result and semantic segmentation result of each object in the object sequence. The edge segmentation image of the object sequence is generated according to the edge detection result. The semantic segmentation image of the object sequence is generated according to the semantic segmentation result.

The trained target segmentation model may be obtained by training an initial target segmentation model using a target training sample. The target training sample may include multiple labeled images, of which each includes an object sequence and labeling information of a class of each object. In some implementation modes, the labeling information of the class of each object may be labeling information for a region, so that a contour of each object may be obtained based on the labeling information of the class of each object. In some other implementation modes, the contour of each object may also be labeled.

The edge detection model is obtained by training based on a sequence object image including object edge labeling information.

The edge detection result includes a result indicating whether each pixel in the image to be recognized is an edge pixel of an object.

A pixel value of each pixel in the edge segmentation image may be a first pixel value or a second pixel value. When a pixel value of a certain pixel is the first pixel value, it indicates that the pixel is an edge pixel of an object. When a pixel value of a certain pixel is the second pixel value, it indicates that the pixel is a non-edge point of an object. The non-edge point of the object may be a point in the object or a point on a background of the object sequence.

In this manner, the image to be recognized may be input to the trained edge detection model and the trained semantic segmentation model to obtain the edge segmentation image and the semantic segmentation image based on the two models, and the image may be processed concurrently through the trained edge detection model and the trained semantic segmentation model, so that the edge segmentation image and the semantic segmentation image may be obtained rapidly.

In some embodiments, S203 may include the following operations. The edge segmentation image and the semantic segmentation image are fused to obtain a fusion image including the semantic segmentation image and the edge information of each object displayed in the semantic segmentation image A pixel value corresponding to a maximum number of pixels in a region corresponding to the edge information of each object is determined in the fusion image.

In this manner, the fusion image includes the semantic segmentation image and the edge information of each object displayed in the semantic segmentation image, so that the edge information of each object and the pixel values of the pixels in the region corresponding to the edge information of each object may be determined accurately to further determine the class of each object in the object sequence accurately.

FIG. 5 is an implementation flowchart of another stacked object recognition method according to an embodiment of the disclosure. As shown in FIG. 5, the method is applied to a stacked object recognition apparatus. The method includes the following operations.

In S501, an image to be recognized is acquired, the image to be recognized including an object sequence formed by stacking at least one object.

In S502, edge detection and semantic segmentation are performed on the object sequence based on the image to be recognized to determine an edge segmentation image of the object sequence and a semantic segmentation image of the object sequence.

In S503, the class of each object in the object sequence is determined based on the edge segmentation image and the semantic segmentation image.

In some embodiments, the object has a value attribute corresponding to the class. Different classes may correspond to the same or different value attributes.

In S504, a total value of objects in the object sequence is determined based on the class of each object and the corresponding value attribute.

A mapping relationship between a class of an object and a value of the object may be configured in the stacked object recognition apparatus. Therefore, a value attribute of each object may be determined based on the mapping relationship and the class of each object.

When the object includes a token, the determined value of each object may be a face value of the token.

The obtained value of each object may be added to obtain the total value of the objects in the object sequence.

In some implementation modes, a surface for placing objects may include multiple placement regions, and objects may be placed in at least one of the multiple placement regions, so that a class of each object in an object sequence placed in each placement region may be determined based on an image to be recognized. One or more object sequences may be placed in one placement region. For example, the class of each object in the object sequence in each placement region may be determined based on an edge segmentation image and a semantic segmentation image.

After the class of each object in the object sequence in each placement region is obtained, a value attribute of each object in the object sequence in each placement region may be determined, and then a total value of objects in each placement region may be determined based on the value attribute of each object in the object sequence in each placement region.

In some implementation modes, whether an action of a game participant conforms to the specification may be determined based on a change of the total value of the objects in each placement region and in combination with the action of the game participant.

When obtained, the total value of the objects in each placement region may be output to a management system for the management system to display. For another example, the total value of each object in each placement region may be output to an action analysis apparatus in a stacked object recognition device such that the action analysis apparatus may determine whether an action of a target around the surface for placing objects conforms to the specification based on a change of the total value of the objects in each placement region.

In the embodiment of the disclosure, the total value of the objects in the object sequence is determined based on the class of each object and the corresponding value attribute, so that it may be convenient to statistically obtain the total value of the stacked object. For example, it is convenient to detect and determine a total value of stacked tokens.

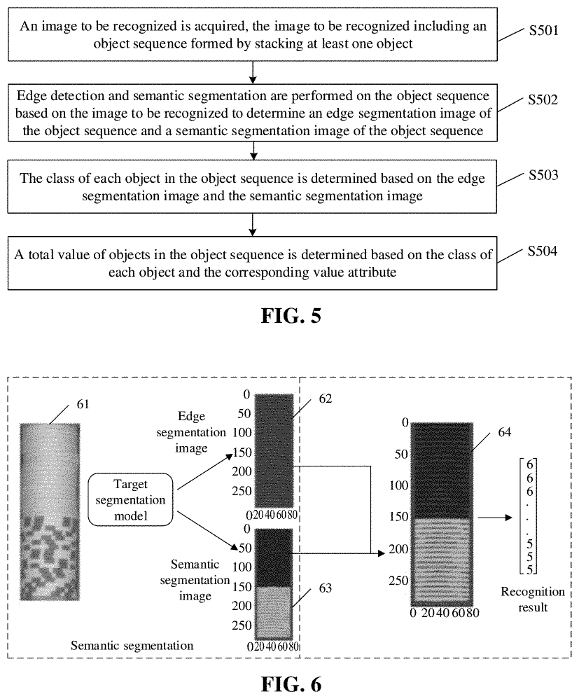

FIG. 6 is a schematic diagram of a flow framework of a stacked object recognition method according to an embodiment of the disclosure. As shown in FIG. 6, an image to be recognized may be an image 61 or include the image 61. The image to be recognized is input to a target segmentation model to obtain an edge segmentation image and a semantic segmentation image. The edge segmentation image may be an image 62 or include the image 62. The semantic segmentation image may be an image 63 or include the image 63.

A contour of each object in an object sequence may be determined based on the image 62, so that the number of the object sequence and a starting position and ending position of each object in the object sequence on a y axis in the image 62 may be determined. In some implementation modes, a starting position and ending position of each object in the object sequence on an x axis in the image 62 may be obtained.

A corresponding position in the image 63 may be determined and labeled to obtain an image 64 based on the starting position and ending position of each object in the image 62 on the y axis in the image 62. An identifier value in each object is determined through the image 64. A class corresponding to the identifier value corresponding to a maximum number in selected identifier values is determined as a class of each object. A contour of each object is labeled in the image 64 more accurately than that in the image 63.

For example, a recognition result may be determined based on the image 64. The recognition result includes the class of each object in the object sequence. For example, the recognition result may include (6, 6, 6, . . . , 5, 5, 5). If 15 classes corresponding to an identifier value 6 and 16 classes corresponding to an identifier value 5 are recognized, the recognition result may include 15 numbers equal to 6 and 15 numbers equal to 5.

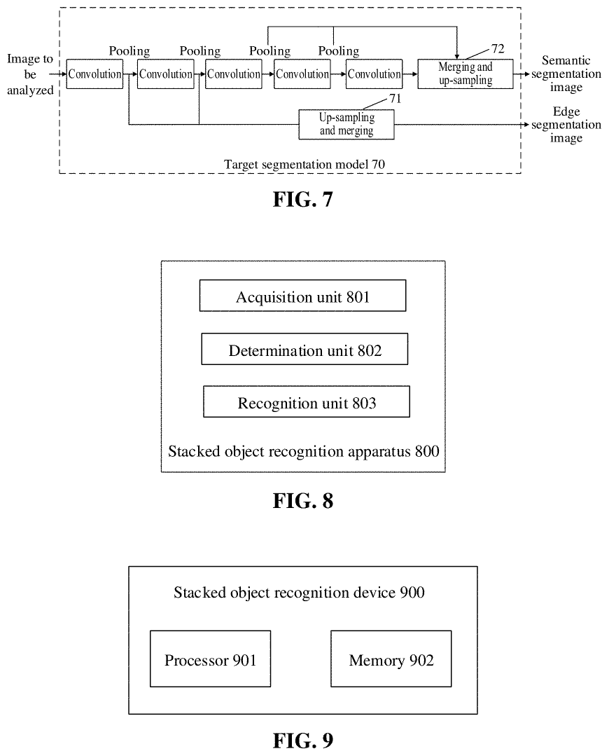

FIG. 7 is a schematic diagram of an architecture of a target segmentation model according to an embodiment of the disclosure. As shown in FIG. 7, five convolution operations and five pooling operations may sequentially be performed on an image to be analyzed based on the target segmentation model 70 to obtain convolved images 1 to 5 and pooled images 1 to 5. The convolved images 1 and 5 may correspond to the abovementioned first convolved image to fifth convolved image respectively. The pooled image 1 may correspond to the abovementioned first pooled image. The pooled images 2 to 3 may correspond to the abovementioned first intermediate images. The pooled images 4 to 5 may correspond to the abovementioned second intermediate images respectively.

An operation of up-sampling and merging 71 may be performed on the convolved images 1 and 2 to obtain an edge segmentation image An operation of merging and up-sampling 72 may be performed on the pooled images 3 to 5 to obtain a semantic segmentation image. In some other embodiments, an operation of up-sampling and merging 71 may be performed on the pooled images 1 and 2 to obtain an edge segmentation image.

Based on the abovementioned embodiments, an embodiment of the disclosure provides a stacked object recognition apparatus. Each unit of the apparatus and each module of each unit may be implemented by a processor in a terminal device, and of course, may also be implemented by a specific logic circuit.

FIG. 8 is a composition structure diagram of a stacked object recognition apparatus according to an embodiment of the disclosure. As shown in FIG. 8, the stacked object recognition apparatus 800 includes an acquisition unit 801, a determination unit 802, and a recognition unit 803.

The acquisition unit 801 is configured to acquire an image to be recognized, the image to be recognized including an object sequence formed by stacking at least one object.

The determination unit 802 is configured to perform edge detection and semantic segmentation on the object sequence based on the image to be recognized to determine an edge segmentation image of the object sequence and a semantic segmentation image of the object sequence, the edge segmentation image including edge information of each object of the object sequence and each pixel in the semantic segmentation image representing a class of the object to which the pixel belongs.

The recognition unit 803 is configured to determine the class of each object in the object sequence based on the edge segmentation image and the semantic segmentation image.

In some embodiments, the recognition unit 803 is further configured to determine a boundary position of each object in the object sequence in the image to be recognized based on the edge segmentation image and determine the class of each object in the object sequence based on pixel values of pixels in a region corresponding to the boundary position of each object in the semantic segmentation image, the pixel value of the pixel representing a class identifier of the object to which the pixel belongs.

In some embodiments, the recognition unit 803 is further configured to, for each object, statistically obtain the pixel values of the pixels in the region corresponding to the boundary position of the object in the semantic segmentation image, determine the pixel value corresponding to a maximum number of pixels in the region according to a statistical result and determine a class identifier represented by the pixel value corresponding to the maximum number of pixels as a class identifier of the object.

In some embodiments, the determination unit 802 is further configured to sequentially perform convolution processing one time and pooling processing one time on the image to be recognized to obtain a first pooled image, perform at least one first operation based on the first pooled image, the first operation including sequentially performing convolution processing one time and pooling processing one time based on an image obtained from latest pooling processing to obtain a first intermediate image, perform merging processing and down-sampling processing on the first pooled image and each first intermediate image to obtain the edge segmentation image, perform at least one second operation based on a first intermediate image obtained from a last first operation, the second operation including sequentially performing convolution processing one time and pooling processing one time based on an image obtained from latest pooling processing to obtain a second intermediate image, and perform merging processing and down-sampling processing on the first intermediate image obtained from the last first operation and each second intermediate image to obtain the semantic segmentation image.

In some embodiments, the edge segmentation image includes a mask image representing the edge information of each object, and/or, the edge segmentation image is the same as the image to be recognized in size.

The semantic segmentation image includes a mask image representing semantic information of each pixel, and/or, the semantic segmentation image is the same as the image to be recognized in size.

In some embodiments, the edge segmentation image is a binarized mask image. A pixel with a first pixel value in the edge segmentation image corresponds to an edge pixel of each object in the image to be recognized. A pixel with a second pixel value in the edge segmentation image corresponds to a non-edge pixel of each object in the image to be recognized.

In some embodiments, the determination unit 802 is further configured to input the image to be recognized to a trained edge detection model to obtain an edge detection result of each object in the object sequence, the edge detection model being obtained by training based on a sequence object image including object edge labeling information, generate the edge segmentation image of the object sequence according to the edge detection result, input the image to be recognized to a trained semantic segmentation model to obtain a semantic segmentation result of each object in the object sequence, the semantic segmentation model being obtained by training based on a sequence object image including object semantic segmentation labeling information, and generate the semantic segmentation image of the object sequence according to the semantic segmentation result.

In some embodiments, the recognition unit 803 is further configured to fuse the edge segmentation image and the semantic segmentation image to obtain a fusion image including the semantic segmentation image and the edge information of each object displayed in the semantic segmentation image, determine a pixel value corresponding to a maximum number of pixels in a region corresponding to the edge information of each object in the fusion image and determine a class represented by the pixel value corresponding to the maximum number of pixels as the class of the object.

In some embodiments, the object has a value attribute corresponding to the class. The determination unit 802 is further configured to determine a total value of objects in the object sequence based on the class of each object and the corresponding value attribute.

The above descriptions about the apparatus embodiments are similar to those about the method embodiments and beneficial effects similar to those of the method embodiments are achieved. Technical details undisclosed in the apparatus embodiments of the disclosure may be understood with reference to those about the method embodiments of the disclosure.

It is to be noted that, in the embodiments of the disclosure, the stacked object recognition method may also be stored in a computer storage medium when implemented in form of a software function module and sold or used as an independent product. Based on such an understanding, the embodiments of the disclosure substantially or parts making contributions to the related art may be embodied in form of a software product. The computer software product is stored in a storage medium, including a plurality of instructions configured to enable a terminal device to execute all or part of the method in each embodiment of the disclosure.

FIG. 9 is a schematic diagram of a hardware entity of a stacked object recognition device according to an embodiment of the disclosure. As shown in FIG. 9, the hardware entity of the stacked object recognition device 900 includes a processor 901 and a memory 902. The memory 902 stores a computer program capable of running in the processor 901. The processor 901 executes the program to implement the steps in the method of any abovementioned embodiment.

The memory 902 stores the computer program capable of running in the processor 901. The memory 902 is configured to store an instruction and application executable for the processor 901, may also cache data (for example, image data, audio data, voice communication data, and video communication data) to be processed or having been processed by the processor 1201 and each module in the stacked object recognition device 900, and may be implemented by a flash or a Random Access Memory (RAM).

The processor 901 executes the program to implement the steps of any abovementioned stacked object recognition method. The processor 901 usually controls overall operations of the stacked object recognition device 900.

An embodiment of the disclosure provides a computer storage medium storing one or more programs which may be executed by one or more processors to implement the steps of the stacked object recognition method in any abovementioned embodiment.

It is to be pointed out here that the above descriptions about the storage medium and device embodiments are similar to those about the method embodiment, and beneficial effects similar to those of the method embodiment are achieved. Technical details undisclosed in the storage medium and device embodiments of the disclosure are understood with reference to those about the method embodiment of the disclosure.

The stacked object recognition apparatus, the chip, or the processor may include any one or integration of multiple of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing unit (CPU), a Graphics Processing Unit (GPU), an embedded Neural-network Processing Unit (NPU), a controller, a microcontroller, and a microprocessor. It can be understood that other electronic devices may also be configured to realize functions of the processor, and no specific limits are made in the embodiments of the disclosure.

The computer storage medium or the memory may be a memory such as a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), or may be any terminal including one or any combination of the abovementioned memories, such as a mobile phone, a computer, a tablet device, and a personal digital assistant.

It is to be understood that “one embodiment” or “an embodiment” or “the embodiment of the disclosure” or “the abovementioned embodiment” or “some implementation modes” or “some embodiments” mentioned in the whole specification means that specific features, structures or characteristics related to the embodiment are included in at least one embodiment of the disclosure. Therefore, “in one embodiment” or “in an embodiment” or “the embodiment of the disclosure” or “the abovementioned embodiment” or “some implementation modes” or “some embodiments” appearing everywhere in the whole specification does not always refer to the same embodiment. In addition, these specific features, structures or characteristics may be combined in one or more embodiments freely as appropriate. It is to be understood that, in each embodiment of the disclosure, a magnitude of a sequence number of each process does not mean an execution sequence and the execution sequence of each process should be determined by its function and an internal logic and should not form any limit to an implementation process of the embodiments of the disclosure. The sequence numbers of the embodiments of the disclosure are adopted not to represent superiority-inferiority of the embodiments but only for description.

If not specified, when the stacked object recognition device executes any step in the embodiments of the disclosure, the processor of the stacked object recognition device executes the step. Unless otherwise specified, the sequence of execution of the following steps by the stacked object recognition device is not limited in the embodiments of the disclosure. In addition, the same method or different methods may be used to process data in different embodiments. It is also to be noted that any step in the embodiments of the disclosure may be executed independently by the stacked object recognition device, namely the stacked object recognition device may execute any step in the abovementioned embodiments independent of execution of the other steps.

In some embodiments provided by the disclosure, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the embodiments.

In addition, each function unit in each embodiment of the disclosure may be integrated into a processing unit, each unit may also serve as an independent unit and two or more than two units may also be integrated into a unit. The integrated unit may be implemented in a hardware form and may also be implemented in form of hardware and software function unit.

The methods disclosed in some method embodiments provided in the disclosure may be freely combined without conflicts to obtain new method embodiments.

The characteristics disclosed in some product embodiments provided in the disclosure may be freely combined without conflicts to obtain new product embodiments.

The characteristics disclosed in some method or device embodiments provided in the disclosure may be freely combined without conflicts to obtain new method embodiments or device embodiments.

Those of ordinary skill in the art should know that all or part of the steps of the method embodiment may be implemented by related hardware instructed through a program, the program may be stored in a computer storage medium, and the program is executed to execute the steps of the method embodiment. The storage medium includes: various media capable of storing program codes such as a mobile storage device, a ROM, a magnetic disk or a compact disc.

Or, the integrated unit of the disclosure may also be stored in a computer storage medium when implemented in form of a software function module and sold or used as an independent product. Based on such an understanding, the embodiments of the disclosure substantially or parts making contributions to the related art may be embodied in form of a software product. The computer software product is stored in a storage medium, including a plurality of instructions configured to enable a computer device (which may be a personal computer, a server, a network device or the like) to execute all or part of the method in each embodiment of the disclosure. The storage medium includes various media capable of storing program codes such as a mobile hard disk, a ROM, a magnetic disk, or an optical disc.

In the embodiments of the disclosure, the descriptions about the same steps and the same contents in different embodiments may refer to those in the other embodiments. In the embodiments of the disclosure, term “and” does not influence the sequence of the steps. For example, that the stacked object recognition device executes A and executes B may refer to that the stacked object recognition device executes B after executing A, or the stacked object recognition device executes A after executing B, or the stacked object recognition device executes B at the same time of executing A.

Singular forms “a/an”, “said” and “the” used in the embodiments and appended claims of the disclosure are also intended to include plural forms unless other meanings are clearly expressed in the context.

It is to be understood that term “and/or” used in the disclosure is only an association relationship describing associated objects and represents that three relationships may exist. For example, A and/or B may represent three conditions: independent existence of A, existence of both A and B and independent existence of B. In addition, character “I” in the disclosure usually represents that previous and next associated objects form an “or” relationship.

It is to be noted that, in each embodiment involved in the disclosure, all the steps may be executed or part of the steps may be executed.

The above is only the implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

What is claimed is:

1. A stacked object recognition method, comprising:
acquiring an image to be recognized, the image to be recognized comprising an object sequence formed by stacking at least one object;
performing edge detection and semantic segmentation on the object sequence based on the image to be recognized to determine an edge segmentation image of the object sequence and a semantic segmentation image of the object sequence, the edge segmentation image comprising edge information of each object of the object sequence and each pixel in the semantic segmentation image representing a class of the object to which the pixel belongs; and
determining the class of each object in the object sequence based on the edge segmentation image and the semantic segmentation image.

2. The method of claim 1, wherein the determining the class of each object in the object sequence based on the edge segmentation image and the semantic segmentation image comprises:
determining a boundary position of each object in the object sequence in the image to be recognized based on the edge segmentation image; and
determining the class of each object in the object sequence based on pixel values of pixels in a region corresponding to the boundary position of each object in the semantic segmentation image, the pixel value of the pixel representing a class identifier of the object to which the pixel belongs.

3. The method of claim 2, wherein the determining the class of each object in the object sequence based on pixel values of pixels in a region corresponding to the boundary position of each object in the semantic segmentation image comprises:
for each object,
statistically obtaining the pixel values of the pixels in the region corresponding to the boundary position of the object in the semantic segmentation image;
determining the pixel value corresponding to a maximum number of pixels in the region according to a statistical result; and
determining a class identifier represented by the pixel value corresponding to the maximum number of pixels as a class identifier of the object.

4. The method of claim 1, wherein the performing edge detection and semantic segmentation on the object sequence based on the image to be recognized to determine an edge segmentation image of the object sequence and a semantic segmentation image of the object sequence comprises:
sequentially performing convolution processing one time and pooling processing one time on the image to be recognized to obtain a first pooled image;
performing at least one first operation based on the first pooled image, the first operation comprising sequentially performing convolution processing one time and pooling processing one time based on an image obtained from latest pooling processing to obtain a first intermediate image;
performing merging processing and down-sampling processing on the first pooled image and each first intermediate image to obtain the edge segmentation image;
performing at least one second operation based on a first intermediate image obtained from a last first operation, the second operation comprising sequentially performing convolution processing one time and pooling processing one time based on an image obtained from latest pooling processing to obtain a second intermediate image; and
performing merging processing and down-sampling processing on the first intermediate image obtained from the last first operation and each second intermediate image to obtain the semantic segmentation image.

5. The method of claim 1, wherein the edge segmentation image comprises a mask image representing the edge information of each object, and/or, the edge segmentation image is the same as the image to be recognized in size;
the semantic segmentation image comprises a mask image representing semantic information of each pixel, and/or, the semantic segmentation image is the same as the image to be recognized in size.

6. The method of claim 5, wherein the edge segmentation image is a binarized mask image, a pixel with a first pixel value in the edge segmentation image corresponds to an edge pixel of each object in the image to be recognized, and a pixel with a second pixel value in the edge segmentation image corresponds to a non-edge pixel of each object in the image to be recognized.

7. The method of claim 1, wherein the performing edge detection and semantic segmentation on the object sequence based on the image to be recognized to determine an edge segmentation image of the object sequence and a semantic segmentation image of the object sequence comprises:
inputting the image to be recognized to a trained edge detection model to obtain an edge detection result of each object in the object sequence, the trained edge detection model being obtained by training based on a sequence object image comprising object edge labeling information;
generating the edge segmentation image of the object sequence according to the edge detection result;
inputting the image to be recognized to a trained semantic segmentation model to obtain a semantic segmentation result of each object in the object sequence, the trained semantic segmentation model being obtained by training based on a sequence object image comprising object semantic segmentation labeling information; and
generating the semantic segmentation image of the object sequence according to the semantic segmentation result.

8. The method of claim 1, wherein the determining the class of each object in the object sequence based on the edge segmentation image and the semantic segmentation image comprises:
fusing the edge segmentation image and the semantic segmentation image to obtain a fusion image, the fusion image comprising the semantic segmentation image and the edge information of each object displayed in the semantic segmentation image;
determining a pixel value corresponding to a maximum number of pixels in a region corresponding to the edge information of each object in the fusion image; and
determining a class represented by the pixel value corresponding to the maximum number of pixels as the class of each object.

9. The method of claim 1, wherein the object has a value attribute corresponding to the class; and the method further comprises:
determining a total value of objects in the object sequence based on the class of each object and the corresponding value attribute.

10. A stacked object recognition device, comprising a memory and a processor,
wherein the memory stores a computer program capable of running in the processor;
wherein when executing the computer program, the processor is configured to:
acquire an image to be recognized, the image to be recognized comprising an object sequence formed by stacking at least one object;
perform edge detection and semantic segmentation on the object sequence based on the image to be recognized to determine an edge segmentation image of the object sequence and a semantic segmentation image of the object sequence, the edge segmentation image comprising edge information of each object of the object sequence and each pixel in the semantic segmentation image representing a class of the object to which the pixel belongs; and
determine the class of each object in the object sequence based on the edge segmentation image and the semantic segmentation image.

11. The device of claim 10, wherein when determining the class of each object in the object sequence based on the edge segmentation image and the semantic segmentation image, the processor is configured to:
determine a boundary position of each object in the object sequence in the image to be recognized based on the edge segmentation image; and
determine the class of each object in the object sequence based on pixel values of pixels in a region corresponding to the boundary position of each object in the semantic segmentation image, the pixel value of the pixel representing a class identifier of the object to which the pixel belongs.

12. The device of claim 11, wherein when determining the class of each object in the object sequence based on the pixel values of pixels in the region corresponding to the boundary position of each object in the semantic segmentation image, the processor is configured to:
for each object,
statistically obtain the pixel values of the pixels in the region corresponding to the boundary position of the object in the semantic segmentation image;
determine the pixel value corresponding to a maximum number of pixels in the region according to a statistical result; and
determine a class identifier represented by the pixel value corresponding to the maximum number of pixels as a class identifier of the object.

13. The device of claim 10, wherein when performing the edge detection and the semantic segmentation on the object sequence based on the image to be recognized to determine the edge segmentation image of the object sequence and the semantic segmentation image of the object sequence, the processor is configured to:
sequentially perform convolution processing one time and pooling processing one time on the image to be recognized to obtain a first pooled image;
perform at least one first operation based on the first pooled image, the first operation comprising sequentially performing convolution processing one time and pooling processing one time based on an image obtained from latest pooling processing to obtain a first intermediate image;
perform merging processing and down-sampling processing on the first pooled image and each first intermediate image to obtain the edge segmentation image;
perform at least one second operation based on a first intermediate image obtained from a last first operation, the second operation comprising sequentially performing convolution processing one time and pooling processing one time based on an image obtained from latest pooling processing to obtain a second intermediate image; and
perform merging processing and down-sampling processing on the first intermediate image obtained from the last first operation and each second intermediate image to obtain the semantic segmentation image.

14. The device of claim 10, wherein the edge segmentation image comprises a mask image representing the edge information of each object, and/or, the edge segmentation image is the same as the image to be recognized in size;
the semantic segmentation image comprises a mask image representing semantic information of each pixel, and/or, the semantic segmentation image is the same as the image to be recognized in size.

15. The device of claim 14, wherein the edge segmentation image is a binarized mask image, a pixel with a first pixel value in the edge segmentation image corresponds to an edge pixel of each object in the image to be recognized, and a pixel with a second pixel value in the edge segmentation image corresponds to a non-edge pixel of each object in the image to be recognized.

16. The device of claim 10, wherein when performing the edge detection and the semantic segmentation on the object sequence based on the image to be recognized to determine the edge segmentation image of the object sequence and the semantic segmentation image of the object sequence, the processor is configured to:
input the image to be recognized to a trained edge detection model to obtain an edge detection result of each object in the object sequence, the trained edge detection model being obtained by training based on a sequence object image comprising object edge labeling information;
generate the edge segmentation image of the object sequence according to the edge detection result;
input the image to be recognized to a trained semantic segmentation model to obtain a semantic segmentation result of each object in the object sequence, the trained semantic segmentation model being obtained by training based on a sequence object image comprising object semantic segmentation labeling information; and
generate the semantic segmentation image of the object sequence according to the semantic segmentation result.

17. The device of claim 10, wherein when determining the class of each object in the object sequence based on the edge segmentation image and the semantic segmentation image, the processor is configured to:
fuse the edge segmentation image and the semantic segmentation image to obtain a fusion image, the fusion image comprising the semantic segmentation image and the edge information of each object displayed in the semantic segmentation image;
determine a pixel value corresponding to a maximum number of pixels in a region corresponding to the edge information of each object in the fusion image; and
determine a class represented by the pixel value corresponding to the maximum number of pixels as the class of each object.

18. The device of claim 10, wherein the object has a value attribute corresponding to the class; and the processor is further configured to:
determine a total value of objects in the object sequence based on the class of each object and the corresponding value attribute.

19. A nonvolatile computer readable storage medium, storing at least one program, wherein when executed by at least one processor, the at least one program is configured to:
acquire an image to be recognized, the image to be recognized comprising an object sequence formed by stacking at least one object;
perform edge detection and semantic segmentation on the object sequence based on the image to be recognized to determine an edge segmentation image of the object sequence and a semantic segmentation image of the object sequence, the edge segmentation image comprising edge information of each object of the object sequence and each pixel in the semantic segmentation image representing a class of the object to which the pixel belongs; and
determine the class of each object in the object sequence based on the edge segmentation image and the semantic segmentation image.
